(19) United States
(12) Patent Application Publication
(10) Pub. No.: US 2026/0086210 A1
(43) Pub. Date: Mar. 26, 2026

(54) LIGHT SOURCE DRIVING APPARATUS AND ELECTRONIC DEVICE

(71) Applicant: Largan Industrial Optics Co., Ltd., Taichung City (TW)

(72) Inventors: Chien Yen CHEN, Taichung City (TW); Tzu-Kan CHEN, Taichung City (TW); Chen-Wei FAN, Taichung City (TW); Ming-Ta CHOU, Taichung City (TW)

(21) Appl. No.: 19/322,810

(22) Filed: Sep. 9, 2025

Related U.S. Application Data
(60) Provisional application No. 63/696,878, filed on Sep. 20, 2024.

(51) Int. Cl. G01S 7/484; G01S 7/4865; G01S 17/894; H05B 47/14

(52) U.S. Cl. CPC G01S 7/484; G01S 7/4865; G01S 17/894; H05B 47/14

(57) ABSTRACT

A light source driving apparatus includes a power supply unit, a TOF module and a signal processing unit. The power supply unit is configured to provide a power source. The TOF module includes a light source unit and a power detecting unit. The light source unit has a light source output power. The power detecting unit is configured to store a default power and detecting the light source output power of the light source unit. The signal processing unit is configured to receive a detecting signal of the power detecting unit. When the light source output power of the light source unit is different from the default power, the signal processing unit transmits an adjusting signal to adjust a supplied output power of the power supply unit.

### RELATED APPLICATIONS

This application claims priority to US Provisional Application Serial Number 63/696,878 filed September 20, 2024, which is herein incorporated by reference.

### BACKGROUND

### TECHNICAL FIELD

The present disclosure relates to a light source driving apparatus and an electronic device.

### DESCRIPTION OF RELATED ART

In prior art, time-of-flight (TOF) modules use a constant voltage to calibrate the optical power of a vertical-cavity surface-emitting laser (VCSEL). However, in practice, problems such as a long supply voltage path or poor printed circuit board (PCB) manufacturing can cause supply voltage drops, leading to unstable VCSEL output power. Furthermore, when the detecting object is close, the TOF module, which uses the constant voltage, cannot dynamically adjust the power, resulting in power consumption.

### SUMMARY

According to one aspect of the present disclosure, a light source driving apparatus includes a power supply unit, a TOF module and a signal processing unit. The power supply unit is configured to provide a power source. The TOF module is coupled to the power supply unit, and includes a light source unit and a power detecting unit. The light source unit has a light source output power. The power detecting unit is coupled to the light source unit, and is configured to store a default power and detecting the light source output power of the light source unit. The signal processing unit is coupled to the power supply unit and the TOF module, and is configured to receive a detecting signal of the power detecting unit. When the light source output power of the light source unit is different from the default power, the signal processing unit transmits an adjusting signal to adjust a supplied output power of the power supply unit.

According to another aspect of the present disclosure, an electronic device includes the light source driving apparatus according to the aforementioned aspect.

According to another aspect of the present disclosure, a light source driving apparatus includes a power supply unit and a TOF module. The power supply unit is configured to provide a power source. The TOF module is coupled to the power supply unit, and includes a light source unit, a power detecting unit and a power IC. The light source unit has a light source output power. The power detecting unit is coupled to the light source unit, and is configured to store a default power and detecting the light source output power of the light source unit. The power IC is coupled to the power detecting unit, and is configured to receive the power from the power supply unit and adjust a power source output power, and transmit the power source output power to the light source unit. When the light source output power of the light source unit is different from the default power, the power IC adjusts the power source output power.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a light source driving apparatus according to the 1st embodiment of the present disclosure.

FIG. 2 is a flow chart of a dynamic power control process of the light source driving apparatus according to the 1st embodiment of FIG. 1.

FIG. 3 is a schematic view of a power detecting unit according to the 1st embodiment of FIG. 1.

FIG. 4 is a schematic view of a driving unit according to the 1st embodiment of FIG. 1.

FIG. 5A is a schematic view of a signal processing unit according to the 1st example of the 1st embodiment of FIG. 1.

FIG. 5B is a schematic view of a signal processing unit according to the 2nd example of the 1st embodiment of FIG. 1.

FIG. 6 is a schematic view of a light source driving apparatus according to the 2nd embodiment of the present disclosure.

FIG. 7 is a schematic view of a light source driving apparatus according to the 3rd embodiment of the present disclosure.

### DETAILED DESCRIPTION

A light source driving apparatus includes a power supply unit, a TOF module and a light source unit. The power supply unit is configured to provide a power source. The TOF module is coupled to the power supply unit, and includes a light source unit and a power detecting unit. The light source unit has a light source output power. The power detecting unit is coupled to the light source unit, and is configured to store a default power and detect the light source output power of the light source unit. The signal processing unit is coupled to the power supply unit and the TOF module, and is configured to receive a detecting signal of the power detecting unit. When the light source output power of the light source unit is different from the default power, the signal processing unit transmits an adjusting signal to adjust a supplied output power of the power supply unit. By the dynamically adjusting the power of the module, a power detecting unit can detect the light source unit's output power. This power is then dynamically adjusted through feedback control to ensure the stability of the light source unit's output power. By adopting the TOF module design with dynamic power adjustment, the light source output power of the light source unit can be detected by the power detecting unit, and the feedback control is applied to dynamically adjust the power, thereby ensuring the stability of the light source output power of the light source unit. Furthermore, when the sensing distance to a sensed object is relatively short, the TOF module can dynamically reduce the light source output power to achieve power-saving benefits.

The light source unit can be a VCSEL module or an edge-emitting laser (EEL) module; the power detecting unit can be a voltage detecting mode, a current detecting mode, or an optical power detecting mode; the memory can be an electrically erasable programmable read-only memory (EEPROM). The signal processing unit can use an inter-integrated circuit (I²C), a serial peripheral interface (SPI), or a universal asynchronous receiver/transmitter (UART), but the present disclosure is not limited thereto.

The error between the light source output power of the light source unit and the default power is between ±1%; more preferably, the error between the light source output power of the light source unit and the default power is between ±0.3%, but the present disclosure is not limited thereto.

The light source driving apparatus can instantly detect the light source output power of the light source unit and dynamically adjust the light source output power of the light source unit. Therefore, the TOF module can be connected to the power supply unit using a PCB in any length, thus it is favorable for avoiding the problem of unstable light source output power of the light source unit caused by voltage drop due to an excessively long circuit or poor PCB manufacturing.

The TOF module further includes a TOF sensor and a driving unit. The TOF sensor is configured to receive a reflecting light of a sensed object and transmit an image signal to the signal processing unit. The driving unit is coupled to the TOF sensor and the light source unit, and includes a driver chip and a transistor. The driver chip is configured to receive an emitting light source time sequence from the TOF sensor, and convert the emitting light source time sequence into an electric signal. The transistor is coupled to the driver chip. The driving unit controls the transistor to turn on and off to control a signal duty cycle, and drives the light source unit to emit a high-frequency modulated laser. Therefore, by controlling the duty cycle of the output signal from the driving unit, it is favorable for dynamically adjusting the light source output power of the light source unit so as to stable the output power of the light source unit, or reduce the output power of the light source unit according to the distance to the sensed object, in order to achieve power-saving purposes.

The TOF sensor can be a CMOS image sensor (CIS), a single-photon avalanche diode (SPAD), an avalanche photodiode (APD), or a silicon photomultiplier (SiPM); the transistor can be a metal-oxide-semiconductor field-effect transistor (MOSFET), but the present disclosure is not limited thereto.

The signal processing unit includes a digital signal processor (DSP) and a digital resistor IC. The DSP is configured to output a resistance control signal. The digital resistor IC is connected to the DSP, and is configured to receive the resistance control signal to generate a corresponding resistance. By controlling the resistance value of a digital resistor IC, it is favorable for dynamically adjusting the supplied output power of the power supply unit.

The signal processing unit further includes a pull-up resistor. The pull-up resistor can be a Zener diode or a pull-up transistor, but the present disclosure is not limited thereto.

The signal processing unit includes a DSP and a filter circuit. The DSP is configured to output a modulated signal. The filter circuit is connected to the DSP, and is configured to suppress an interference noise of the modulated signal. By dynamically outputting the modulated signal, it is favorable for dynamically adjusting the supplied output power of the power supply unit.

The filter circuit is a resistor-capacitor (RC) filter circuit or an inductor-capacitor (LC) filter circuit. The input end of the DSP of the signal processing unit can also include an analog to digital converter (ADC) to convert analog signals into digital signals for processing. The output end of the DSP can also include a digital to analog converter (DAC) to convert the processed digital signals back into analog signals for output. The DSP can control power output by adjusting voltage or current, but the present disclosure is not limited thereto. By providing the RC filter circuit or the LC filter circuit, it is favorable for eliminating the high-frequency noise so as to prevent the control signal output by the DSP from being interfered with.

The signal processing unit receives the image signal of the TOF sensor, and resets the default power stored in the power detecting unit according to a distance of the sensed object. When the image signal received by the signal processing unit indicates that the sensed object is close, a lower default power is set to save power consumption of the light source unit. Conversely, when the sensed object is far away, the default power is increased to enhance brightness of the light source unit and improve the accuracy of TOF.

The TOF module further includes a connecting unit. The connecting unit is configured to connect the power supply unit, the signal processing unit, the power detecting unit, the TOF sensor and the driving unit. Therefore, it is not necessary to additionally define pin assignments for the connecting unit on the TOF module. Instead, data can be accessed by the firmware through different addresses or locations, allowing connection to the existing I²C bus, and thereby further reducing development costs.

According to another aspect of the present disclosure, a light source driving apparatus includes a power supply unit and a TOF module. The power supply unit is configured to provide a power source. The TOF module is coupled to the power supply unit, and includes a light source unit, a power detecting unit and a power IC. The light source unit has a light source output power. The power detecting unit is coupled to the light source unit, and is configured to store a default power and detect the light source output power of the light source unit. The power IC is coupled to the power detecting unit, and is configured to receive the power from the power supply unit and adjust a power source output power, and transmit the power source output power to the light source unit. When the light source output power of the light source unit is different from the default power, the power IC adjusts the power source output power. By integrating the power IC on the TOF module, the output power of the power supply can be dynamically adjusted, and it is favorable for the TOF module being compatible with more types of system side modules, such as the power supply unit that outputs fixed power, unstable power, or has a limited adjustable power range. As a result, no hardware modification on the system side is needed, and dynamic power adjustment can be achieved simply through firmware programming, thereby avoiding increased costs caused by hardware changes.

The TOF module further includes a Micro Control Unit (MCU). The MCU is coupled to the power detecting unit and the power IC, and is configured to receive a detecting signal from the power detecting unit. When the light source output power of the light source unit is different from the default power, the MCU transmits an adjusting signal to control the power IC to adjust the power source output power. By integrating the MCU, the system side processing unit can be replaced, no hardware and firmware modification on the system side is needed, and it is favorable for being applied to various types of system side modules.

The MCU reads the signal from the power detecting unit via the I²C bus, but the present disclosure is not limited thereto. By integrating the light source unit, the power detecting unit, the power IC and the MCU in the TOF module, it is favorable for dynamically adjusting the light source output power of the light source unit more quickly.

The power supply unit is a power supply module with a fixed power. By integrating the power IC into the TOF module, it is favorable for dynamically adjusting the output power of the power supply, and allowing the use of existing fixed-power supply modules without modifying the system side modules so as to reduce development costs.

An electronic device includes the aforementioned light source driving apparatus.

Each of the aforementioned features of the light source driving apparatus can be utilized in various combinations for achieving the corresponding effects. According to the above embodiment, specific examples are proposed below and explained in detail with the drawings.

### <1st Embodiment>

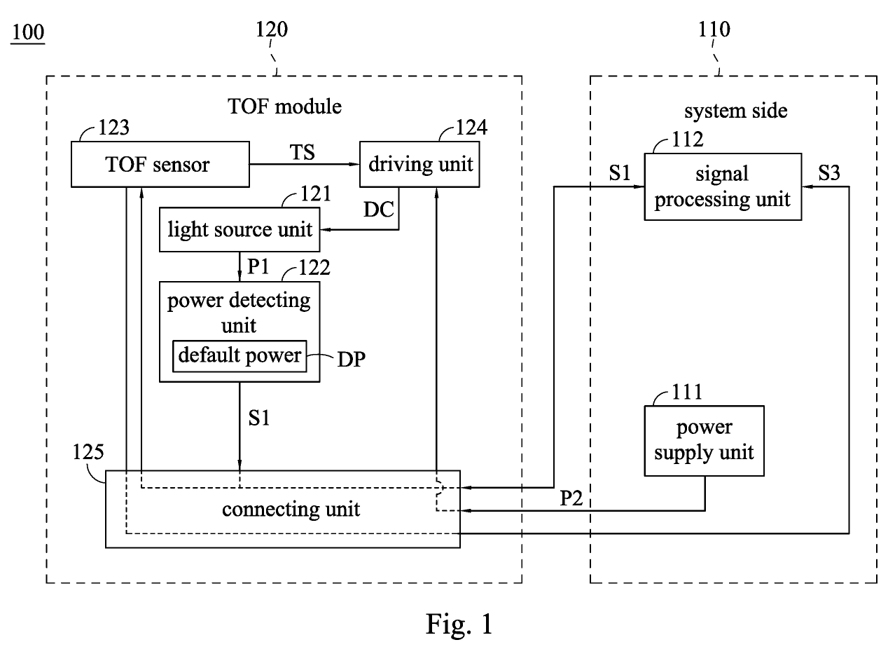

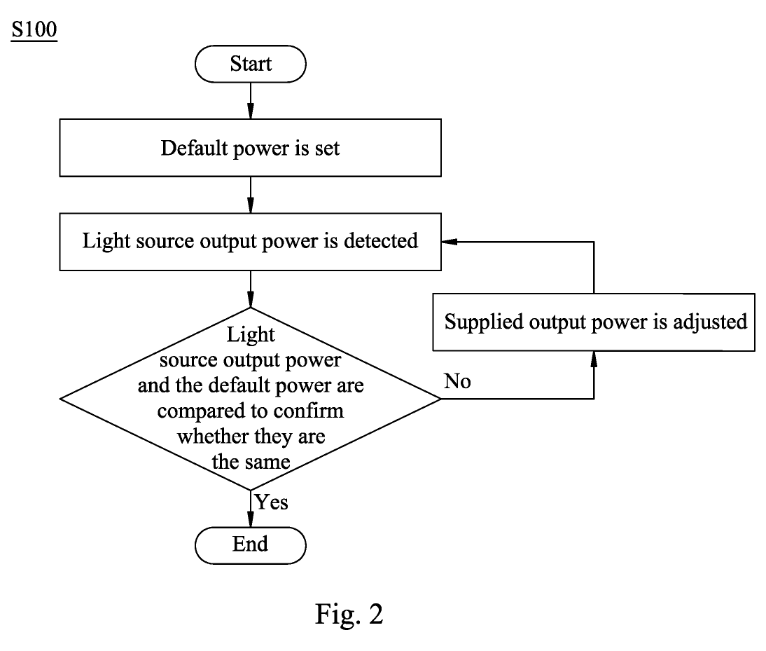

FIG. 1 is a schematic view of a light source driving apparatus 100 according to the 1st embodiment of the present disclosure. FIG. 2 is a flow chart of a dynamic power control process S100 of the light source driving apparatus 100 according to the 1st embodiment of FIG. 1. As shown in FIG. 1 and FIG. 2, in the 1st embodiment, the light source driving apparatus 100 can be applied to an electronic device such as a computer or a mobile phone (not shown). A light source driving apparatus 100 includes a system side 110 and a TOF module 120, the TOF module 120 is coupled to the system side 110. The system side 110 includes a power supply unit 111 and a signal processing unit 112. The TOF module 120 includes a light source unit 121, a power detecting unit 122, a TOF sensor 123 and a driving unit 124. The power supply unit 111 is coupled to the driving unit 124 of the TOF module 120, the signal processing unit 112 is coupled to the power supply unit 111, the power detecting unit 122 and the TOF sensor 123 of the TOF module 120. The signal processing unit 112 is coupled to the power detecting unit 122 and the driving unit 124, the power detecting unit 122 is coupled to the TOF sensor 123, the TOF sensor 123 is coupled to the driving unit 124. In the 1st embodiment, the light source unit 121 is a VCSEL module; the signal processing unit 112 uses an I²C communication signal transmission method.

The power supply unit 111 is configured to provide a power source (not shown). The light source unit 121 has a light source output power P1. The power detecting unit 122 is configured to store a default power DP and detect the light source output power P1 of the light source unit 121. The signal processing unit 112 is configured to receive a detecting signal S1 of the power detecting unit 122. When the light source output power P1 of the light source unit 121 is different from the default power DP, the signal processing unit 112 transmits an adjusting signal S2 to adjust a supplied output power P2 of the power supply unit 111. It should be noted that, if the error between the light source output power P1 and the default power DP is greater than a predetermined range, it means that he light source output power P1 and the default power DP are different. In the 1st embodiment, the error between the light source output power P1 of the light source unit 121 and the default power DP is within ±1%.

As shown in FIG. 2, the dynamic power control process S100 of the light source driving apparatus 100 is as follows: First, the default power DP is set and stored in the power detecting unit 122. Next, the light source output power P1 of the light source unit 121 is detected by the power detecting unit 122. Next, the light source output power P1 is received by the signal processing unit 112 via the I²C detecting signal S1, and the light source output power P1 and the default power DP are compared to see if they are the same (i.e., the error between the light source output power P1 and the default power DP is less than a preset range). When the light source output power P1 does not reach the default power DP, the signal processing unit 112 transmits the adjusting signal S2 to control the power supply unit 111 to adjust the supplied output power P2. Furthermore, the light source output power P1 of the light source unit 121 will be detected again by the power detecting unit 122, and the difference value will be detected again. This cycle is repeated until the light source output power P1 of the light source unit 121 is the same as the default power DP (that is, the error between the light source output power P1 and the default power DP is less than ±1%).

In addition, the signal processing unit 112 can receive an image signal S3 from the TOF sensor 123 and reset the default power DP stored in the power detecting unit 122 according to a distance of the sensed object.

Therefore, the light source driving apparatus 100 can instantly detect the light source output power P1 of the light source unit 121 and dynamically adjust the light source output power P1, and it is favorable for ensuring the stability of the light source output power P1 of the light source unit 121. Additionally, the power can be dynamically reduced when the detection distance of the sensed object is short so as to achieve the purpose of saving power.

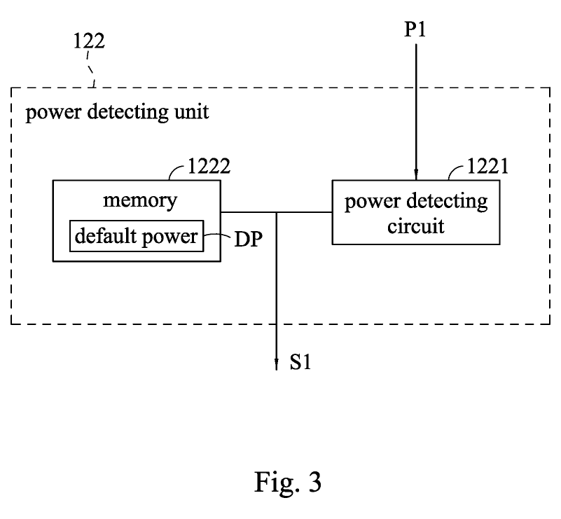

FIG. 3 is a schematic view of a power detecting unit 122 according to the 1st embodiment of FIG. 1. As shown in FIG. 1 and FIG. 3, the power detecting unit 122 includes a power detecting circuit 1221 and a memory 1222, the power detecting circuit 1221 is coupled to the memory 1222. The power detecting circuit 1221 is configured to detect the light source output power P1 of the light source unit 121. The power detecting circuit 1221 is used to detect the light source output power P1 of the light source unit 121, and then transmits the detected light source output power P1 and the default power DP stored in the memory 1222 to the signal processing unit 112 via the detecting signal S1 of the I²C bus. The signal processing unit 112 then compares the difference between the light source output power P1 and the default power DP. In the 1st embodiment, the power detecting circuit 1221 of the power detecting unit 122 is in the optical power detecting mode; and the memory 1222 is the EEPROM.

As shown in FIG. 1, the TOF sensor 123 is configured to receive the reflecting light of the sensed object and transmit the image signal S3 to the signal processing unit 112. In the 1st embodiment, the TOF sensor 123 is SPAD.

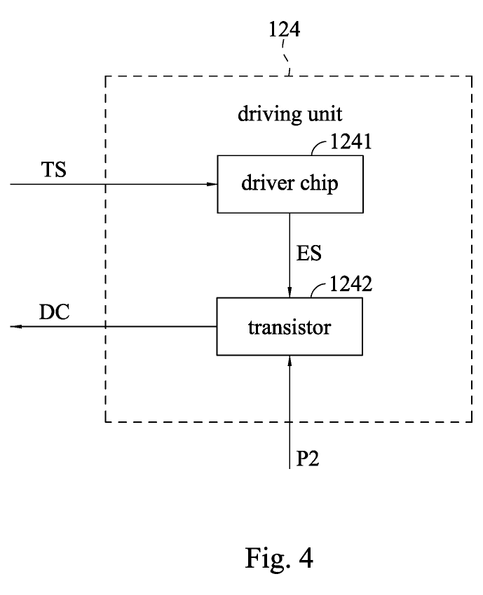

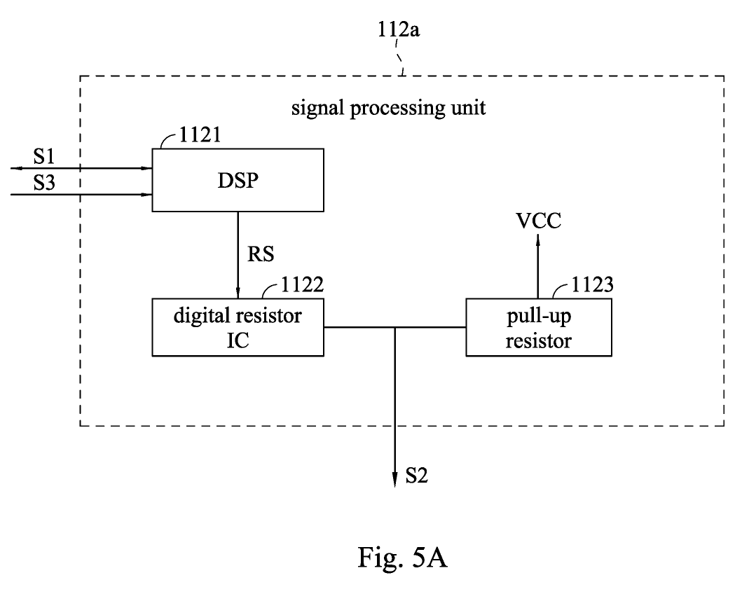

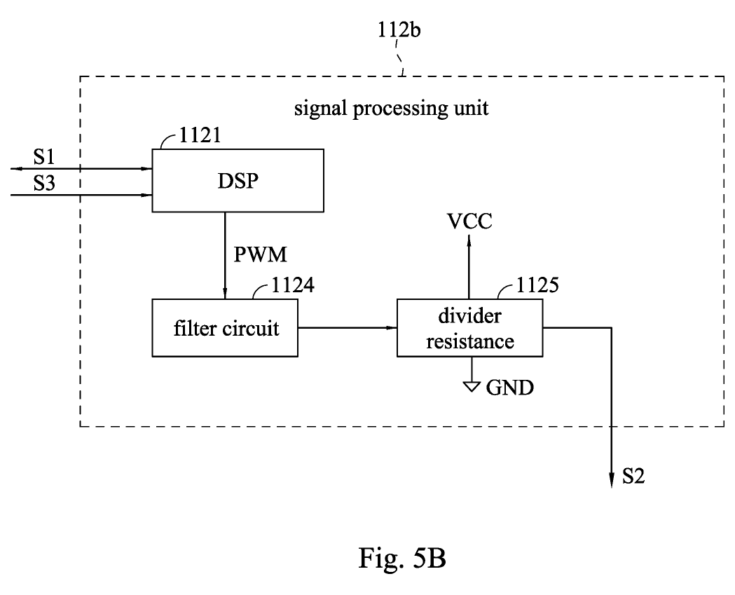

FIG. 4 is a schematic view of a driving unit 124 according to the 1st embodiment of FIG. 1. As shown in FIG. 1 and FIG. 4, the driving unit 124 includes a driver chip 1241 and a transistor 1242, the transistor 1242 is coupled to the driver chip 1241. The driver chip 1241 is configured to receive an emitting light source time sequence TS from the TOF sensor 123, and convert the emitting light source time sequence TS into an electric signal ES. The driving unit 124 controls the transistor 1242 to turn on and off to control a signal duty cycle DC. In the 1st embodiment, the transistor 1242 is a MOSFET. It should be noted that, the emitting light source time sequence TS is an optical signal that indicates whether the light source is turned on or off at a specific time, thereby encoding and transmitting information. When the driving unit 124 receives the emitting light source time sequence TS from the TOF sensor 123, it controls the signal duty cycle DC and outputs the corresponding modulated signal PWM (as shown in FIG. 5B) to the light source unit 121.

In detail, the driver chip 1241 receives the emitting light source time sequence TS output by the TOF sensor 123 and converts it into a single-point signal. Then, the transistor 1242 controls the duty cycle DC, driving light source unit 121 to emit a high-frequency modulated laser.

FIG. 5A is a schematic view of a signal processing unit 112a according to the 1st example of the 1st embodiment of FIG. 1. As shown in FIG. 1 and FIG. 5A, in the 1st example of the 1st embodiment, the signal processing unit 112a includes a DSP 1121 , a digital resistor IC 1122 and a pull-up resistor 1123. The DSP is configured to output a resistance control signal. The digital resistor IC 1122 is connected to the DSP 1121 and the pull-up resistor 1123. The digital resistor IC 1122 and the pull-up resistor 1123 are connected in series to a power terminal VCC. The DSP 1121 is configured to output a resistance control signal RS. The digital resistor IC 1122 is configured to receive the resistance control signal RS to generate a corresponding resistance. The DSP 1121 can dynamically adjust the supplied output power P2 of the power supply unit 111 by controlling the resistance of the digital resistor IC 1122. In the 1st example of the 1st embodiment, the pull-up resistor 1123 is Zener diode.

In detail, the DSP 1121 receives the detecting signal S1 from the power detecting unit 122 and the image signal S3 from the TOF sensor 123, and compares the difference between the light source output power P1 and the default power DP. When the light source output power P1 does not reach the default power DP, the DSP 1121 transmits the adjusting signal S2 to notify power supply unit 111 to adjust the supplied output power P2. The resistance control signal RS is output by the DSP 1121 to control the resistance value of the digital resistor IC 1122, thereby controlling the power output.

Further, the input end of the DSP 1121 can also include an ADC (not shown) to convert analog signals into digital signals for processing. The output end of the DSP 1121 can also include a DAC (not shown) to convert the processed digital signals back into analog signals for output.

Therefore, when the image signal S3 received by the DSP 1121 indicates that the distance of the sensed object is closer, the adjusting signal S2 can be output to reduce the power to save the power consumption of the light source unit 121.

FIG. 5B is a schematic view of a signal processing unit 112b according to the 2nd example of the 1st embodiment of FIG. 1. As shown in FIG. 1 and FIG. 5B, in the 2nd example of the 1st embodiment, the signal processing unit 112b includes a DSP 1121, a filter circuit 1124 and a divider resistance 1125. The filter circuit 1124 is connected to the DSP 1121 and the divider resistance 1125. The filter circuit 1124 and the divider resistance 1125 are connected in series to a power terminal VCC. The divider resistance 1125 is connected to a ground terminal GND.

The DSP 1121 is configured to output the modulated signal PWM to dynamically adjust the supplied output power P2 of the power supply unit 111. The filter circuit 1124 is configured to suppress an interference noise of the modulated signal PWM. In the 2nd example of the 1st embodiment, the filter circuit 1124 is the RC filter circuit.

As shown in FIG. 1, the TOF module 120 of the light source driving apparatus 100 further includes a connecting unit 125. The connecting unit 125 is configured to connect the power supply unit 111, the signal processing unit 112, the power detecting unit 122, the TOF sensor 123 and the driving unit 124.

<2nd Embodiment>

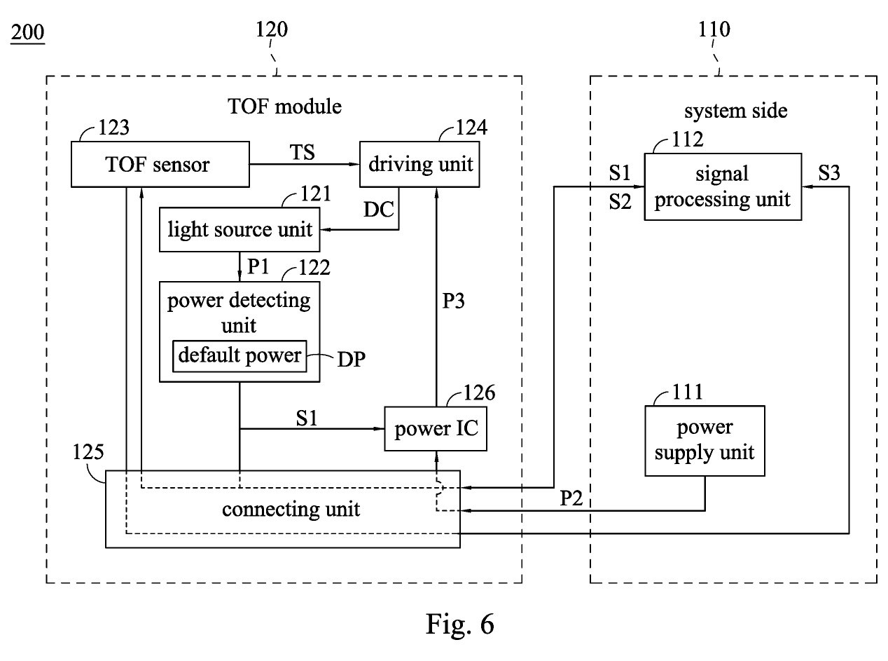

FIG. 6 is a schematic view of a light source driving apparatus 200 according to the 2nd embodiment of the present disclosure. As shown in FIG. 6, in the 2nd embodiment, the light source driving apparatus 200 also includes the power supply unit 111, the signal processing unit 112, the light source unit 121, the power detecting unit 122, the TOF sensor 123, the driving unit 124, and the connecting unit 125 in FIG. 1. The difference between the light source driving apparatus 200 of the 2nd embodiment and the light source driving apparatus 100 of the 1st embodiment lies in that the TOF module 120 further includes a power IC 126, the connection relationship between the power supply unit 111, the signal processing unit 112 and the driving unit 124, and the power supply unit 111 is the fixed-power module. Specifically, the power IC 126 is coupled to the power supply unit 111, the power detecting unit 122, the driving unit 124 and the connecting unit 125. The power supply unit 111 is not coupled to the signal processing unit 112 and the driving unit 124, and the supplied output power P2 of the power supply unit 111 is a constant power.

The power IC 126 is configured to receive the power from the power supply unit 111 and adjust a power source output power P3, and transmit the power source output power P3 to the light source unit 121 through the driving unit 124. When the light source output power P1 of the light source unit 121 is different from the default power DP, the power IC 126 adjusts the power source output power P3. In detail, the signal processing unit 112 can read the detecting signal S1 of the power detecting unit 122 through the I²C bus first to the connecting unit 125, and then send the adjusting signal S2 to the power IC 126. After receiving the adjusting signal S2 via the I²C bus, the power IC 126 adjusts the constant power input from the power supply unit 111 and dynamically readjusts the power source output power P3 output to the driving unit 124.

<3rd Embodiment>

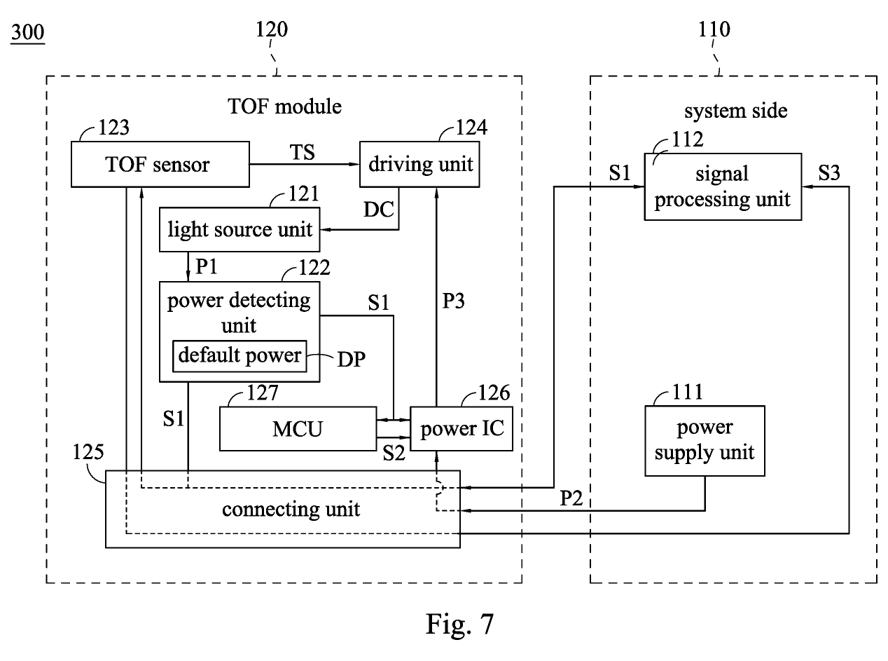

FIG. 7 is a schematic view of a light source driving apparatus 300 according to the 3rd embodiment of the present disclosure. As shown in FIG. 7, in the 3rd embodiment, the light source driving apparatus 300 also includes the power supply unit 111, the signal processing unit 112, the light source unit 121, the power detecting unit 122, the TOF sensor 123, the driving unit 124, the connecting unit 125, and the power IC 126 in FIG. 6. The difference between the light source driving apparatus 300 of the 3rd embodiment and the light source driving apparatus 200 of the 2nd embodiment lies in the TOF module 120 of the light source driving apparatus 300 further includes a MCU 127. Specifically, the MCU 127 is coupled to the power detecting unit 122 and the power IC 126.

The MCU 127 is configured to receive a detecting signal S1 from the power detecting unit 122. The MCU 127 reads the detecting signal S1 from the power detecting unit 122 via the I²C bus and controls the power IC 126 to dynamically adjust the power. When the light source output power P1 of the light source unit 121 is different from the default power DP, the MCU 127 transmits an adjusting signal S2 to control the power IC 126 to adjust the power source output power P3. In detail, the dynamic power control can be integrated from the system side 110 to the TOF module 120 via the MCU 127. In the 3rd embodiment, the MCU 127 is a microcontroller.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light source driving apparatus, comprising:
a power supply unit configured to provide a power source;
a TOF module coupled to the power supply unit, and comprising:
a light source unit having a light source output power; and
a power detecting unit coupled to the light source unit, and configured to store a default power and detecting the light source output power of the light source unit; and
a signal processing unit coupled to the power supply unit and the TOF module, and configured to receive a detecting signal of the power detecting unit;
wherein, when the light source output power of the light source unit is different from the default power, the signal processing unit transmits an adjusting signal to adjust a supplied output power of the power supply unit.

2. The light source driving apparatus of claim 1, wherein the TOF module further comprises:
a TOF sensor configured to receive a reflecting light of a sensed object and transmit an image signal to the signal processing unit; and
a driving unit coupled to the TOF sensor and the light source unit, and comprising:
a driver chip configured to receive an emitting light source time sequence from the TOF sensor, and convert the emitting light source time sequence into an electric signal; and
a transistor coupled to the driver chip;
wherein, the driving unit controls the transistor to turn on and off to control a signal duty cycle, and drives the light source unit to emit a high-frequency modulated laser.

3. The light source driving apparatus of claim 1, wherein the signal processing unit comprises:
a DSP configured to output a resistance control signal; and
a digital resistor IC connected to the DSP, and configured to receive the resistance control signal to generate a corresponding resistance.

4. The light source driving apparatus of claim 1, wherein the signal processing unit comprises:
a DSP configured to output a modulated signal; and
a filter circuit connected to the DSP, and configured to suppress an interference noise of the modulated signal.

5. The light source driving apparatus of claim 4, wherein the filter circuit is a resistor-capacitor filter circuit or an inductor-capacitor filter circuit.

6. The light source driving apparatus of claim 2, wherein the signal processing unit receives the image signal of the TOF sensor, and resets the default power stored in the power detecting unit according to a distance of the sensed object.

7. The light source driving apparatus of claim 2, wherein the TOF module further comprises:
a connecting unit configured to connect the power supply unit, the signal processing unit, the power detecting unit, the TOF sensor and the driving unit.

8. An electronic device, comprising:
the light source driving apparatus of claim 1.

9. A light source driving apparatus, comprising:
a power supply unit configured to provide a power source; and
a TOF module coupled to the power supply unit, and comprising:
a light source unit having a light source output power;
a power detecting unit coupled to the light source unit, and configured to store a default power and detecting the light source output power of the light source unit; and
a power IC coupled to the power detecting unit, and configured to receive the power from the power supply unit and adjust a power source output power, and transmit the power source output power to the light source unit;
wherein, when the light source output power of the light source unit is different from the default power, the power IC adjusts the power source output power.

10. The light source driving apparatus of claim 9, wherein the TOF module further comprises:
a TOF sensor configured to receive a reflecting light of a sensed object and transmit an image signal to a signal processing unit; and
a driving unit coupled to the TOF sensor and the light source unit, and comprising:
a driver chip configured to receive an emitting light source time sequence from the TOF sensor, and convert the emitting light source time sequence into an electric signal; and
a transistor coupled to the driver chip;
wherein, the driving unit controls the transistor to turn on and off to control a signal duty cycle, and drives the light source unit to emit a high-frequency modulated laser.

11. The light source driving apparatus of claim 10, wherein the signal processing unit receives the image signal of the TOF sensor, and resets the default power stored in the power detecting unit according to a distance of the sensed object.

12. The light source driving apparatus of claim 9, wherein the TOF module further comprises:
a MCU coupled to the power detecting unit and the power IC, and configured to receive a detecting signal from the power detecting unit;
wherein, when the light source output power of the light source unit is different from the default power, the MCU transmits an adjusting signal to control the power IC to adjust the power source output power.

13. The light source driving apparatus of claim 10, wherein the TOF module further comprises:
a connecting unit configured to connect the power supply unit, the signal processing unit, the power detecting unit, the TOF sensor and the power IC.

14. The light source driving apparatus of claim 9, wherein the power supply unit is a power supply module with a fixed power.

15. An electronic device, comprising:
the light source driving apparatus of claim 9.
